(19) United States
(12) Patent Application Publication
(10) Pub. No.: US 2016/0355134 A1
(43) Pub. Date: Dec. 8, 2016

(54) Back-up Camera System for Towed Trailer

(71) Applicant: Rhett Clinton Leary, Chuluota, FL (US)

(72) Inventor: Rhett Clinton Leary, Chuluota, FL (US)

(21) Appl. No.: 15/172,816

(22) Filed: Jun. 3, 2016

Related U.S. Application Data
(60) Provisional application No. 62/171,270, filed on Jun. 5, 2015.

(51) Int. Cl. B60R 1/00; H04W 4/00; H04N 5/225; B60R 11/04; H04N 7/18

(52) U.S. Cl. CPC B60R 1/002; B60R 11/04; H04N 7/183; H04N 5/2256; H04W 4/008; B60R 2300/105; B60R 2300/806

(57) ABSTRACT

A back-up camera system for a towed trailer captures video feed behind the trailer. The system is comprised of a video camera, a monitor, and a control unit which provides an operating switch. The camera is mounted on the rear surface of the trailer and captures video feed behind the trailer. The camera transmits the video feed by wire to the control unit located in the cabin of the vehicle. The control unit transmits the video feed wirelessly to the monitor that displays the video feed to the user. The operating switch enables the user to activate the camera and control unit in order to see behind the trailer while driving, backing up, or parking.

### CROSS-REFERENCE TO RELATED APPLICATIONS

This application claims the benefit of U.S. Provisional Application No. 62/171,270, filed Jun. 5, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to trailer towing equipment and in particular to a back-up camera system for a towed trailer. For the non-professional driver, towing a boat trailer, camper, cargo trailer, or other trailer is often very difficult, particularly since the driver may not get very much practice in this area. Backing up the trailer is especially challenging, since the area immediately behind the trailer is blocked from the driver's rear-view mirrors.

A search of the prior art reveals various cameras and camera systems which have been developed to provide the driver a view of the area immediately behind the trailer while sitting in the driver's seat. None are closely related to the present invention, but several include features which resemble those of the present invention. Each has proven to be less than satisfactory in its own way.

Tractor-trailer viewing system, U.S. Pat. No. 6,690,413 (priority Apr. 21, 1999), provides an automated, universal trailer rear viewing system that is integrated in its entirety on the head or pulling portion of a pivotally connected articulated vehicle. The system includes: (a) at least one image capturing device mounted on the tractor designed to tilt, pan and focus on a target object or an area around the trailer; (b) a computer located inside the tractor coupled to the image capturing device; (c) an image capturing and comparative software program loaded into the memory of the computer capable of processing the image file of the target object transmitted from the image capturing device, and capable of generating control commands to the image capturing device so that an image of the target object is maintained as the system is activated; (d) at least one adjustable viewing camera also coupled to the computer that automatically adjusts the viewing camera tilting, panning and focusing according to the movement of the image capturing device; and, (e) at least one display monitor located near the driver that is coupled to the viewing camera so that the image seen thereby may be seen by the driver.

Vehicle vision system with trailer angle detection, U.S. Patent App. Pub. No. US2014/0160276 (priority Sep. 26, 2012), provides a vehicular vision system which includes at least one camera and an image processor. The camera is disposed at a vehicle and has an exterior field of view rearward of the vehicle. The camera is operable to capture image data. The image processor is operable to process captured image data. The vision system, responsive at least in part to image processing of captured image data, is operable to determine a trailer angle of a trailer that is towed by the vehicle. The vision system is operable to determine a path of the trailer responsive to a steering angle of the vehicle and the vision system is operable to display information for viewing by the driver to assist the driver in driving the vehicle with the trailer.

Vehicle video system, U.S. Patent App. Pub. No. US2014/0071279 (filed Sep. 10, 2012) provides a system which includes a vehicle body defining a cargo area, a display mounted to the vehicle, a first video camera and an image processor. The first video camera is fixedly mounted to the vehicle at a first fixed location in a prescribed orientation relative to the vehicle to capture a video image of the cargo area. The image processor is operatively coupled to the first video camera and the display to process the video image captured by the first video camera and to stream a simulated video overhead view including at least a portion of the cargo area on the display.

Video camera suitable for mounting on road vehicle or trailer for road vehicle has housing which may fit on edge of shelf and has removable cover for camera lens, German Patent No. 20219004 (priority Sep. 6, 2002), provides a video camera with an elongated housing which may be fastened to the rear of the vehicle and has a sliding lens cover in its middle portion. When the cover is in its open position, the lens is exposed and the camera may operate. The housing may be made in a variety of different configurations, and the lens cover may be made in a single piece or may be a small roller blind.

Trailer monitoring system, German Patent No. 19816822 (priority Apr. 26, 1997), provides a security system with one or more cameras fitted to the trailer and linked to a display in the driving position. At least one of the cameras is mounted to cover the rear view from the trailer. The data link between the cameras and the display can be cable or a non cable remote link. The image processing and the display provide information on the spacing of the vehicle from obstructions. The vehicle can be provided with several sites to hold the cameras. The sites can have plug in connectors for the cable link to the towing vehicles.

Portable wireless rearview camera system for a vehicle, U.S. Patent App. Pub. No. 2006/0098094 (filed Nov. 8, 2004), provides a system which is comprised of a movable weather resistant camera housing unit that wirelessly transmits images to the movable display unit. The weather resistant camera housing unit comprises a video camera to capture images behind the vehicle and a wireless transmitter to transmit the images to the movable display unit. The camera housing unit is connected to the vehicle or its attached trailer by a shielded magnet, which can easily be removed for use on another vehicle or to prevent its theft. The movable display unit comprises a wireless receiver coupled with a video monitor to display the images transmitted from the rear view camera to provide the vehicle's driver with a real time image of what is behind the vehicle.

The prior art inventions require the driver to look away from the windshield and rear view mirrors of the vehicle in order to view the image provided by the camera or cameras. The prior art inventions typically only provide a view when the vehicle is backing. The prior art inventions do not include illumination behind the trailer for the camera video view. The present invention has been developed for the purpose of addressing and resolving these disadvantages. A back-up camera system for a towed trailer, which provides a camera on the rear of the trailer and a monitor which may be mounted on the vehicle's windshield would operate whenever the vehicle is driving, backing up, or parking with the trailer attached, and would provide illumination behind the trailer for the camera video view. These elements would resolve these problems.

### SUMMARY OF THE INVENTION

Accordingly, the invention is directed to a back-up camera system for a towed trailer. The system is comprised of a video camera, a monitor, and a control unit which may provide an operating switch. The camera is mounted on the rear surface of the trailer and captures video feed behind the trailer. The camera transmits the video feed by wire to the control unit located in the cabin of the vehicle. The control unit wirelessly transmits the video feed to the monitor, which displays the video feed to the user. The operating switch enables the user to activate the camera and monitor in order to see behind the trailer while driving, backing, or parking. The camera system is capable of providing a view behind the trailer when driving, backing up, or parking. The LED lights on the camera provide illumination for the video view behind the trailer during night operations. The primary purpose for this invention is to provide additional safety measures to the user that could save lives and prevent costly property damages whenever a vehicle is driving, backing up, or parking a trailer.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide further understanding of the invention and are incorporated into and constitute a part of the specification. They illustrate one embodiment of the invention and, together with the description, serve to explain the principles of the invention.

FIG. 1 is a front view of the monitor component of the first exemplary embodiment, displaying the monitor 10, and the mounting bracket 11.

FIG. 2 is a front view of the power cord component of the first exemplary embodiment, displaying the power cord 12.

FIG. 3 is a side view of the monitor component of the first exemplary embodiment, displaying the monitor 10, and the mounting bracket 11.

FIG. 4 is a front perspective view of the control unit component of the first exemplary embodiment, displaying the control unit 13, and the antenna 14.

FIG. 5 is a side view of the vehicle video/power cable component of the first exemplary embodiment, displaying the vehicle video/power cable 15, and the male plug 16.

FIG. 6 is a side view of the trailer video/power cable component of the first exemplary embodiment, displaying the trailer video/power cable 17, and the female plug 18.

FIG. 7 is a front view of the camera component of the first exemplary embodiment, displaying the camera 19, and the LED lights 20.

FIG. 8 is a front perspective view of the camera component of the first exemplary embodiment, displaying the camera 19, and the LED lights 20.

FIG. 9 is a side elevation view of a trailer 33, displaying the rear surface 32 and front end 36.

FIG. 10 is a side elevation view of a vehicle 35, displaying the cabin 34 and the trailer hitch 37.

FIG. 11 is a perspective view of the interior of a vehicle, displaying the lighter power port 38 and the existing dashboard backup monitor 39.

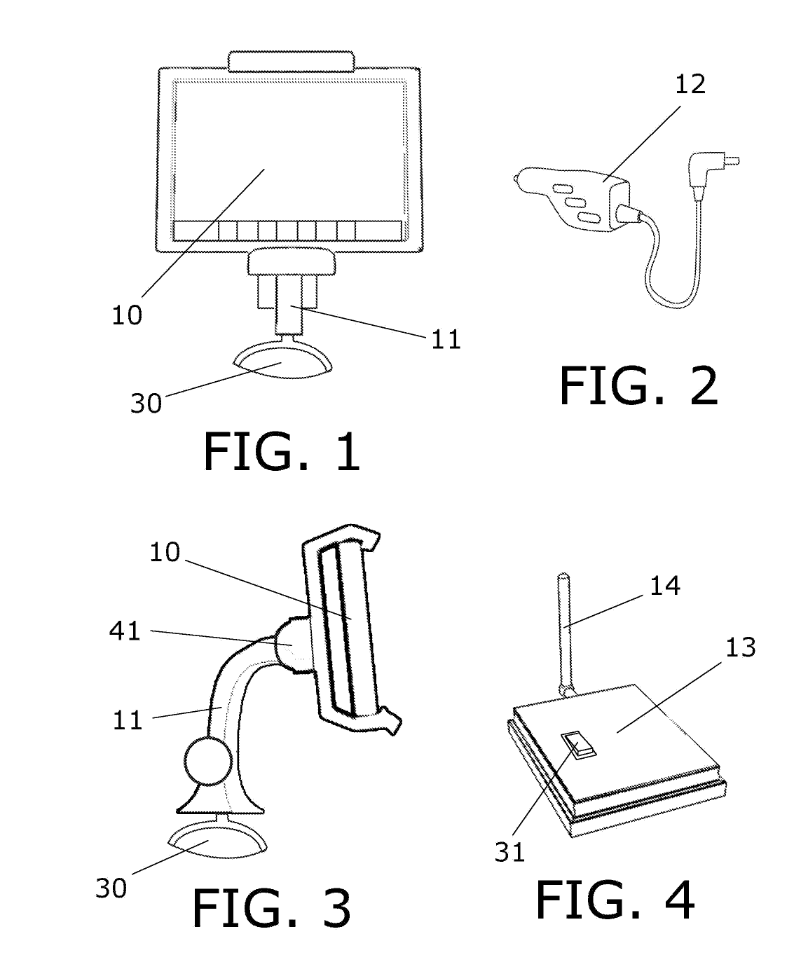

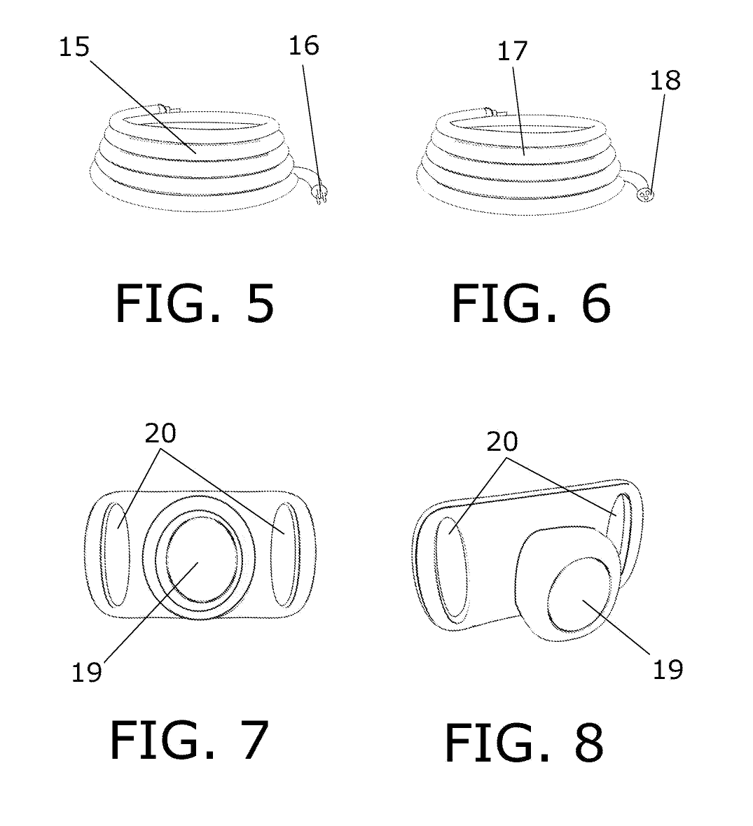

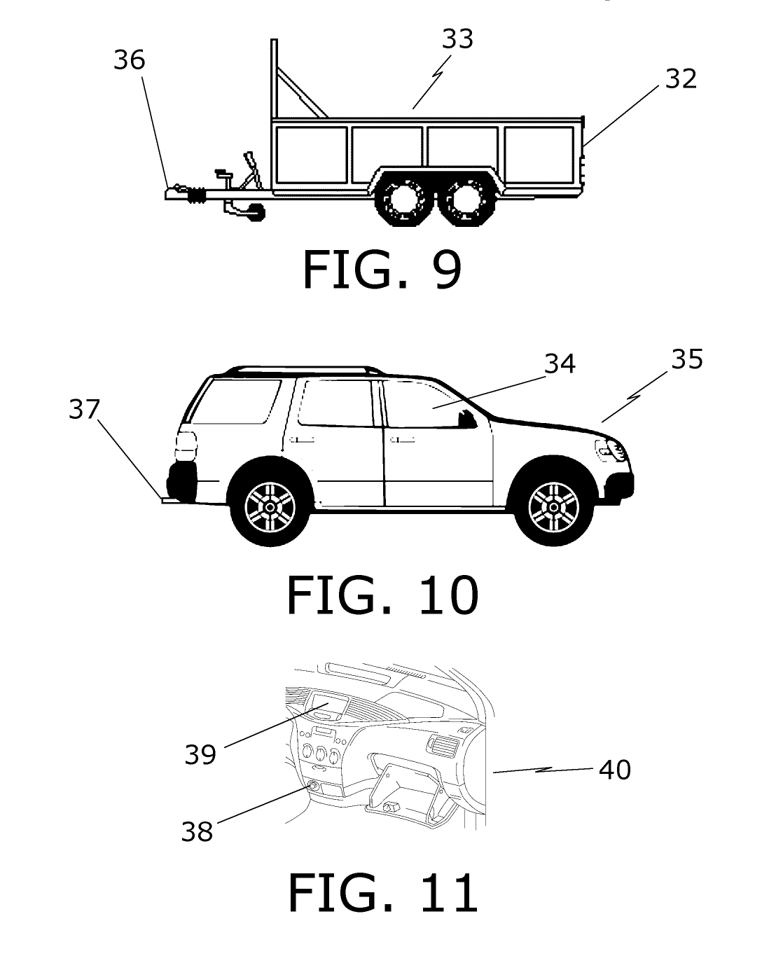

### DETAILED DESCRIPTION OF THE INVENTION

Referring now to the invention in more detail, the invention is directed to a back-up camera system for a towed trailer.

The first exemplary embodiment is comprised of a video camera 19, a monitor 10, and control unit 13 which may provide an operating switch 31. The camera 19 is mounted on the rear surface 32 of the trailer 33 and captures video from behind the trailer 33. The camera 19 generates a video signal and transmits the video signal via a trailer cable 17 and vehicle cable 15 to the control unit 13, which provides an antenna 14 mounted on a ball and socket joint. The control unit 13 converts the video signal into a wireless signal and wirelessly transmits the video signal to the monitor 10, located in the cabin 34 of the vehicle 35. The monitor 10 converts the wireless signal back into a video signal and displays the video feed to the user. The operating switch 31 enables the user to activate the camera 19 and control unit 13 in order to see behind the trailer 33 while driving, backing, or parking.

The monitor 10 and its mounting bracket 11 are preferably similar in dimensions, appearance, and configuration to a windshield-mounted GPS navigation device, providing a suction cup 30 for mounting on the interior surface 40 of the vehicle windshield. The mounting bracket 11 also preferably provides a ball and socket joint 41 in order to allow the user to rotate, tilt, or turn the monitor. This allows the user to best position the monitor 10 for viewing. The monitor 10 provides a view from the camera 19 on the rear surface 32 of the trailer 33 during towing and backing operations. While driving on the roadway, the view from the camera 19 assists the user to confirm that the rear of the trailer 32 is sufficiently beyond a nearby vehicle for passing. While backing the trailer, the view from the camera 19 allows the user to confirm that nothing is behind the trailer 33 and assists with guiding and stopping.

The camera 19 is preferably waterproof and is permanently attached at the rear surface 32 of the trailer 33, providing LED lights 20 to illuminate the area behind the trailer 33 when backing up the trailer at night. A trailer cable 17 is provided to the front 36 of the trailer 33 and terminates with a female plug 18. The male plug 16 is attached near the trailer hitch 37 with the vehicle cable 15 extending into the cabin 34, where it connects to the control unit 13. The monitor 10 is plugged into the lighter port 38 for power, using a removable power cord 12.

The control unit 13 is preferably connected directly to the electrical system of the vehicle. When the male plug 16 is connected to the female plug 18, the vehicle cable 15 and the trailer cable 17 provide electric power and control signals to the camera 19, and conveys the video signal to the control unit 13. Multiple cameras 19 and trailer cables 17 may be purchased separately and used with the same monitor 10 for users with more than one trailer 33 or with multiple cameras on one trailer 33.

An alternate embodiment, capable of synchronization with the existing dashboard backup monitor 39 in newer vehicles, is contemplated. When a trailer is attached to the vehicle and the vehicle cable 15 and the trailer cable 17 are connected, shifting the vehicle in reverse will cause the existing vehicle camera to be bypassed and the existing dashboard backup monitor 39 will provide the view from the trailer camera 19 rather than the existing backup camera. Alternatively, the existing dashboard backup monitor 39 may be activated with a dashboard switch. The dashboard switch would activate the camera and the existing dashboard backup monitor 39 to display the video signal when the vehicle is driving, parking, or backing up.

To use the first exemplary embodiment, the user may activate the operating switch on the control unit 13. Subsequent operation of the system is automatic.

Electronic components of the control unit 13 preferably include a memory device, a microprocessor, a rod antenna 14, and a transmitter capable of operating on radio frequency (RF) or any one of several other short range wireless data communications protocols. Electronic components of the monitor 10 preferably include a memory device, a microprocessor, an internal ring antenna, and a receiver capable of operating on radio frequency (RF) or any one of several other short range wireless data communications protocols, in coordination with the transmitter in the control unit.

The monitor 10, the mounting bracket 11, the control unit 13, and the camera 19 are preferably manufactured from rigid, durable materials, such as stainless steel, brass, aluminum alloy, plastic, methacrylate, and copper alloy. The power cable 12, the vehicle video/power cable 15 and the trailer video/power cable 17 are preferably manufactured from braided copper alloy wire sheathed in plastic. The LED lights 20 are preferably manufactured from rigid, durable materials such as glass, plastic, methacrylate, and aluminum alloy, contained in a waterproof housing which is preferably manufactured from a rigid, durable material such as plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A back-up camera system for a towed trailer, comprising: a video camera; the video camera being configured to mount on a rear surface of a trailer; a trailer cable being capable of transferring a video signal and having two ends; said trailer cable being attached at a first end to the video camera; a second end of the trailer cable terminating with a female connector at a front end of the trailer; a vehicle cable being capable of transferring the video signal and having two ends; said vehicle cable being attached at a first end to a control unit; a second end of the vehicle cable terminating with a male connector; the male connector of the vehicle cable and the female connector of the trailer cable being configured to connect such that the video signal may be transferred between the trailer cable and the vehicle cable; said control unit being capable of wirelessly broadcasting the video signal; a monitor; the monitor being capable of receiving and displaying the wirelessly broadcasted video signal.

2. The camera system of claim 1, wherein the camera captures video, the camera transmits the video signal to the trailer cable, the trailer cable transmits the video signal to the vehicle cable, and the vehicle cable transmits the video signal to the control unit; the control unit converts the video signal into a wireless signal.

3. The camera system of claim 2, wherein the control unit further comprises an operating switch; said control unit broadcasting the wireless signal when said operating switch is activated; said control unit not broadcasting the wireless signal when said operating switch is deactivated.

4. The camera system of claim 3, wherein the monitor converts the wireless signal broadcast by the control unit into a video signal and displays the video.

5. The camera system of claim 1, wherein the monitor further comprises a mounting bracket; the mounting bracket being configured to removably attach the monitor to an interior surface of a vehicle cabin.

6. The camera system of claim 5, wherein the mounting bracket includes a suction cup and a ball and socket joint, such that the monitor may be turned, tilted, or rotated.

7. The camera system of claim 1, wherein the video camera is waterproof.

8. The camera system of claim 1, wherein the video camera is permanently attached to the rear surface of the trailer.

9. The camera system of claim 1, wherein the video camera further comprises LED lights such that the area behind the trailer is illuminated when the video camera is activated.

10. The camera system of claim 1, wherein the male connector of the vehicle cable terminates near a trailer hitch of a vehicle and extending into a cabin of the vehicle, where it connects to the control unit.

11. The camera system of claim 1, wherein the monitor further comprises a removable power cord; said removable power cord being plugged into a lighter port of a vehicle, such that the lighter port provides power to the monitor; and the control unit is connected directly to an electrical system of the vehicle, such that the electrical system of the vehicle provides power to the control unit when the electrical system is activated.

12. The camera system of claim 1, wherein the vehicle cable is further configured to transfer power from the control unit to the trailer cable; the trailer cable is further configured to transfer power from the vehicle cable to the video camera; such that when the control unit is connected to the video camera via the vehicle cable and trailer cable the video camera is provided power and is activated and transmits a video signal to the control unit.

13. The camera system of claim 1, wherein a plurality of video cameras are connected to the control unit via a plurality of separate trailer cables and vehicle cables; said control unit being capable of switching between the plurality of video camera signals such that only one video camera signal is broadcast wirelessly to the monitor; said monitor being capable of controlling which video camera signal is sent from the control unit.

14. The camera system of claim 1, wherein a plurality of video cameras are connected to the control unit via a plurality of separate trailer cables and vehicle cables; said control unit being capable of combining the separate signals of the plurality of video cameras such that only one video signal is broadcast wirelessly to the monitor; said monitor being capable of displaying all video signals at the same time; said monitor being capable of selectively displaying only a single video signal.

15. A back-up camera system for a towed trailer, comprising: a trailer video camera; the trailer video camera being configured to mount on a rear surface of a trailer; a trailer cable being capable of transferring a video signal and having two ends; said trailer cable being attached at a first end to the trailer video camera; a second end of the trailer cable terminating with a female connector at a front end of the trailer; a vehicle cable being capable of transferring the video signal and having two ends; said vehicle cable being attached at a first end to an existing dashboard backup monitor of a vehicle with an existing backup camera; a second end of the vehicle cable terminating with a male connector; the male connector of the vehicle cable and the female connector of the trailer cable being configured to connect such that the video signal may be transferred between the trailer cable and the vehicle cable; the existing dashboard backup monitor being configured to override a signal from an existing backup camera when the trailer video camera is attached to the existing dashboard backup monitor via the trailer cable and vehicle cable.

16. The camera system of claim 15, wherein the trailer video camera captures video, the camera transmits the video signal to the trailer cable, the trailer cable transmits the video signal to the vehicle cable, and the vehicle cable transmits the video signal to the existing dashboard backup monitor; and the existing dashboard backup monitor is capable of displaying the video signal when an electrical system of the vehicle is activated.

17. The camera system of claim 15, wherein the trailer video camera is waterproof.

18. The camera system of claim 15, wherein the trailer video camera is permanently attached to the rear surface of the trailer.

19. The camera system of claim 15, wherein the trailer video camera further comprises LED lights such that the area behind the trailer is illuminated when the video camera is activated.

20. The camera system of claim 15, wherein the vehicle cable is further configured to transfer power from the existing dashboard backup monitor to the trailer cable; the trailer cable is further configured to transfer power from the vehicle cable to the trailer video camera; such that when the existing dashboard backup monitor is connected to the video camera via the vehicle cable and trailer cable the trailer video camera is provided power, is activated, and transmits a video signal to the existing dashboard backup monitor.
